(19) United States
(12) Patent Application Publication
(10) Pub. No.: US 2017/0160763 A1
(43) Pub. Date: Jun. 8, 2017

(54) LOW-POWER PULSED BANDGAP REFERENCE

(71) Applicant: Marvell World Trade Ltd., St. Michael (BB)

(72) Inventor: Cedric Barbelenet, Boudry (CH)

(21) Appl. No.: 15/364,334

(22) Filed: Nov. 30, 2016

Related U.S. Application Data
(60) Provisional application No. 62/262,590, filed on Dec. 3, 2015.

(51) Int. Cl. G05F 3/08

(52) U.S. Cl. CPC G05F 3/08

(57) ABSTRACT

An electronic circuit includes a bandgap circuit, a capacitor, a switch and a control circuit. The bandgap circuit is configured to generate a predefined reference voltage. The capacitor is coupled to an output port of the electronic circuit on which an output voltage is to be provided. The switch is connected between the bandgap circuit and the capacitor. The control circuit is configured to control the bandgap circuit and the switch so as to alternate between: first time intervals, during which the bandgap circuit is enabled and connected to the capacitor, the capacitor is charged using the reference voltage generated by the bandgap circuit, and the reference voltage is provided as the output voltage on the output port; and second time intervals, during which the bandgap circuit is disabled and disconnected from the capacitor, and the output voltage on the output port is supplied from the capacitor.

### CROSS-REFERENCE TO RELATED APPLICATIONS

This application claims the benefit of U.S. Provisional Patent Application 62/262,590, filed Dec. 3, 2015, whose disclosure is incorporated herein by reference.

### FIELD OF THE DISCLOSURE

The present disclosure relates generally to voltage supplies, and particularly to methods and systems for supplying reference voltages.

### BACKGROUND

Bandgap voltage reference circuits are commonly used for providing accurate reference voltages in electronic circuits. In some circuits and applications, low power consumption is a prime design consideration that has impact on power supply design. Stringent requirements on power consumption exist, for example, in battery-powered equipment having sleep modes, in network devices, and in many other types of electronic devices.

The description above is presented as a general overview of related art in this field and should not be construed as an admission that any of the information it contains constitutes prior art against the present patent application.

### SUMMARY

An embodiment that is described herein provides an electronic circuit including a bandgap circuit, a capacitor, a switch and a control circuit. The bandgap circuit is configured to generate a predefined reference voltage. The capacitor is coupled to an output port of the electronic circuit on which an output voltage is to be provided. The switch is connected between the bandgap circuit and the capacitor. The control circuit is configured to control the bandgap circuit and the switch so as to alternate between: first time intervals, during which the bandgap circuit is enabled and connected to the capacitor, the capacitor is charged using the reference voltage generated by the bandgap circuit, and the reference voltage is provided as the output voltage on the output port; and second time intervals, during which the bandgap circuit is disabled and disconnected from the capacitor, and the output voltage on the output port is supplied from the capacitor.

In some embodiments, the control circuit is configured to transition between the first time intervals and the second time intervals by setting interim time intervals in which the bandgap circuit is enabled but disconnected from the capacitor. In an embodiment, the switch includes three transistors connected in a T-network configuration.

In an embodiment, an average current consumption of the electronic circuit is lower than an instantaneous current consumption of the bandgap circuit. In an example embodiment, the instantaneous current consumption of the bandgap circuit, when enabled, is higher than 13 μA, and the average current consumption of the electronic circuit is lower than 1 μA. In a disclosed embodiment, the bandgap circuit, the capacitor, the switch and the control circuit are sub-micron Complementary Metal Oxide Semiconductor (CMOS) components implemented in a single Integrated Circuit (IC).

There is additionally provided, in accordance with an embodiment that is described herein, a method for supplying electrical power. The method includes operating a bandgap circuit that is configured to generate a predefined reference voltage, a capacitor coupled to an output port on which an output voltage is to be provided, and a switch connected between the bandgap circuit and the capacitor. The bandgap circuit and the switch are controlled so as to alternate between: first time intervals, during which the bandgap circuit is enabled and connected to the capacitor, the capacitor is charged using the reference voltage generated by the bandgap circuit, and the reference voltage is provided as the output voltage on the output port; and second time intervals, during which the bandgap circuit is disabled and disconnected from the capacitor, and the output voltage on the output port is supplied from the capacitor.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates power supply circuitry in an Integrated Circuit (IC), in accordance with an embodiment that is described herein;

FIG. 2 is a diagram that schematically illustrates phases of operation of the switched bandgap reference circuit of FIG. 1, in accordance with an embodiment that is described herein;

FIG. 3 is a timing diagram showing signal waveforms during the phases of operation depicted in FIG. 2, in accordance with an embodiment that is described herein;

FIG. 4 is a circuit diagram showing current leakage in the switched bandgap reference circuit of FIG. 1, in accordance with an embodiment that is described herein; and

FIG. 5 is a circuit diagram that schematically illustrates a low-leakage switch used in a switched bandgap reference circuit, in accordance with an embodiment that is described herein.

### DETAILED DESCRIPTION OF EMBODIMENTS

Embodiments that are described herein provide improved electronic circuits and associated methods for supplying accurate reference voltages. The disclosed techniques utilize a bandgap reference circuit that generates a highly accurate reference voltage. In order to reduce average power consumption of the electronic circuit, in an embodiment, the bandgap reference circuit is disabled most of the time, and enabled only intermittently for short time intervals.

In some embodiments, the electronic circuit comprises a bandgap reference circuit, a capacitor, a switch and a control circuit. The capacitor is coupled to an output port of the electronic circuit, on which an output voltage is provided. The switch is connected between the output of the bandgap reference circuit and the output port. The control circuit is configured to enable and disable the bandgap reference circuit, and to close and open the switch.

During the short time intervals in which the bandgap reference circuit is enabled, the control circuit closes the switch, and thus connects the bandgap reference circuit to the capacitor and the output port. During these intervals the reference voltage supplied by the bandgap reference circuit is provided as the output voltage, and also used for charging the capacitor. During the remaining time, while the bandgap reference circuit is disabled, the control circuit opens the switch, and the output voltage is supplied by the capacitor.

In practice, the length of time for which the bandgap reference circuit can be kept disabled depends, to a large extent, on the leakage current of the switch. In some embodiments, the switch is designed for very low leakage current, e.g., using three transistors connected in a T-network configuration. When using this sort of switch, the bandgap reference circuit can be disabled for relatively long periods of time, while still maintaining the output voltage within specified limits. As a result, power consumption is further reduced.

The circuits and associated methods described herein facilitate, for example, the use of a medium-power bandgap reference circuit, while achieving power consumption similar to that of ultra-low-power bandgap reference circuits. When implemented in a sub-micron (e.g., 0.028μ, i.e., 28 nm) Complementary Metal Oxide Semiconductor (CMOS) process, for example, this solution eliminates the inherent drawbacks of ultra-low-power bandgap reference circuits, without compromising output-voltage accuracy.

For example, unlike ultra-low-power bandgap reference circuits, the disclosed circuits are characterized by very low leakage current, close correlation between design simulation and actual performance, very small unit-to-unit process-related variations, and fast start-up and response time. Moreover, the disclosed techniques achieve noise and precision performance typical of medium-power bandgap reference circuit.

In an example implementation, the instantaneous current consumption of the medium-power bandgap circuit, when enabled, is higher than 13 μA. When pulsed in accordance with the disclosed techniques, the average current consumption decreases to below 1 μA, with negligible degradation in output voltage precision.

The disclosed techniques are useful, for example, in Integrated Circuits (ICs) having low-power sleep modes, such as ICs used in battery-powered equipment.

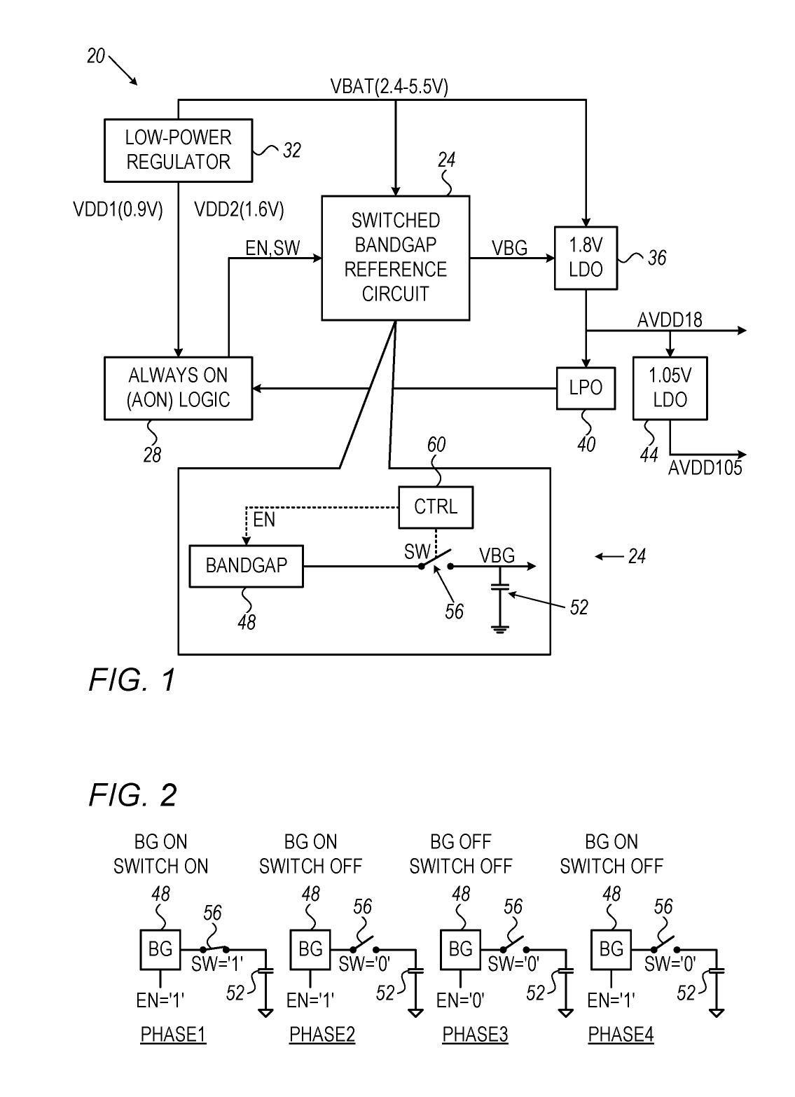

FIG. 1 is a block diagram that schematically illustrates a power supply circuit 20 in an Integrated Circuit (IC), in accordance with an embodiment that is described herein. Circuit 20 can be used in any suitable type of IC. Typically, although not necessarily, circuit 20 supplies operating voltages for an IC in a mobile communication or computing device that supports one or more power-saving sleep modes. One non-limiting example of such a device is a Near-Field Communication (NFC) device. Other example applications comprise ICs in other types of mobile devices such as Wi-Fi or Bluetooth devices, wearable equipment, power-management ICs, and automotive equipment, to name only a few.

In the present example, circuit 20 is powered by a battery whose voltage (denoted VBAT) is in the range 2.4-5.5V. For clarity, FIG. 1 focuses on the operation of circuit 20 during a “deep-sleep” power-saving mode, in which the requirement for low power consumption is most stringent.

In the embodiment of FIG. 1, circuit 20 comprises Always-On (AON) logic 28, which is powered from VBAT by a low-power regulator 32. Regulator 32 generates two regulated voltages denoted VDD1 (0.9V) and VDD2 (1.6V), typically on separate lines. AON logic 28 is active continuously as long as battery power is present, regardless of the mode of operation of circuit 20. In an embodiment, regulator 32 consumes approximately 1.2 μA. Circuit 20 further comprises a switched bandgap (BG) reference circuit 24, which is configured to produce a highly accurate reference voltage denoted VBG. The structure and operation of circuit 24 is addressed in detail below.

In the present example, circuit 20 produces two accurate regulated voltages—1.8V and 1.05V. Voltage VBG is supplied as input to a Low Drop-Out regulator (LDO) 36 that outputs the 1.8V output voltage (denoted AVDD18). An additional LDO 44 generates the 1.05V voltage (denoted AVDD105) from the 1.8V voltage AVDD18. Voltage AVDD18 is also used for powering a Low-Power Oscillator (LPO) 40 that clocks AON logic 28. In an example embodiment, LPO 40 generates a 256 KHz clock signal and consumes approximately 300 nA.

An inset at the bottom of the figure illustrates the internal structure of switched bandgap reference circuit 24, in an embodiment. Circuit 24 comprises a bandgap (BG) reference circuit 48, a capacitor 52, a switch 56 and a control circuit 60. (In some embodiments control circuit 60 is part of AON logic 28. Nevertheless, circuit 60 is depicted separately from logic 28 in the figure for the sake of clarity.) In an embodiment, BG reference circuit 48 is a medium-power BG reference circuit that consumes approximately 13.3 μA when active, and capacitor 52 is a 1 pF capacitor. Circuit 24 provides VBG as output. VBG is also referred to herein as a reference voltage (VREF) and as the output voltage of circuit 24.

Capacitor 52 is coupled to an output port of circuit 24, on which the output voltage VBG is provided. Switch 56 is connected between the output of bandgap reference circuit 48 and the output port. Control circuit 60 is configured to enable and disable bandgap reference circuit 48, and to close and open switch 56. In some embodiments, control circuit 60 controls bandgap reference circuit 48 and switch 56 in a periodic pattern of time intervals, also referred to as “phases.”

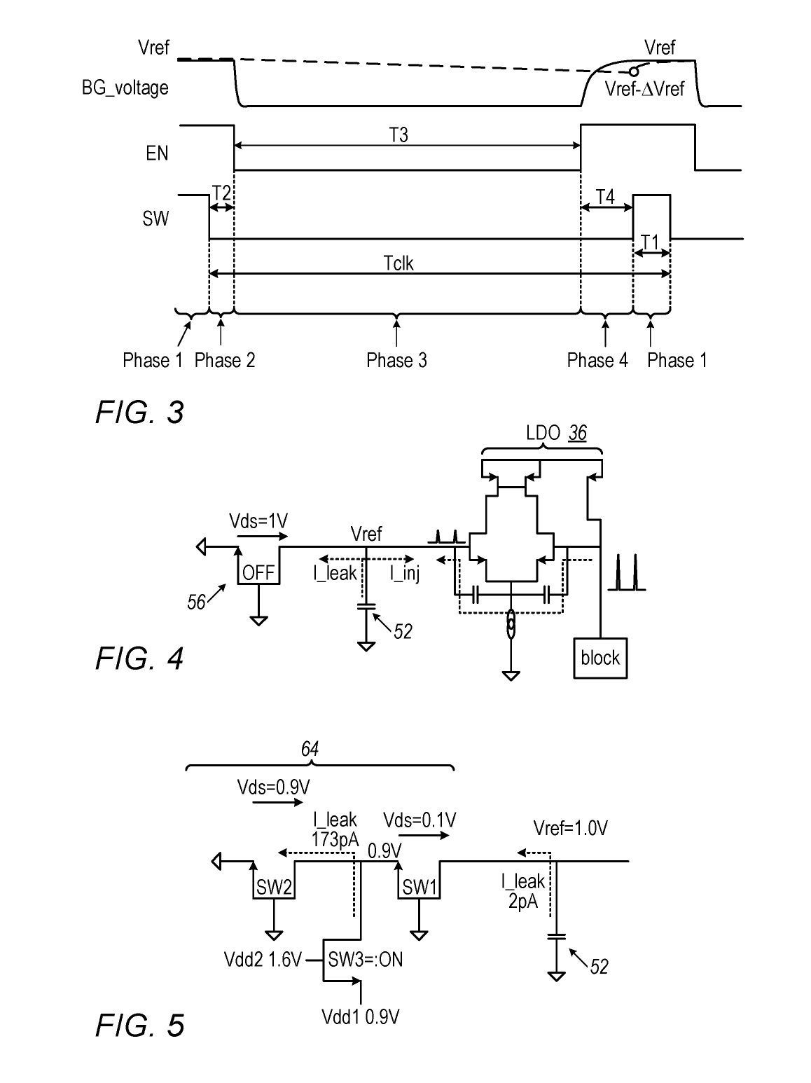

Reference is now made to FIGS. 2 and 3. FIG. 2 is a diagram that schematically illustrates a periodic pattern of phases in which control circuit 60 operates switched bandgap reference circuit 24, and FIG. 3 is a timing diagram showing corresponding signal levels, in accordance with an embodiment that is described herein. In the present example, each period of the pattern comprises four time intervals denoted “PHASE 1” through “PHASE 4”. Generally speaking, PHASE 1 is a phase in which BG reference circuit 48 is active, PHASE 3 is a phase in which BG reference circuit 48 is disabled, and PHASE 2 and PHASE 4 are transition phases intended to prevent undesired transient responses.

In PHASE 1, control circuit 60 enables BG reference circuit 48 by setting an enable signal (denoted EN) to EN=“1”, and closes switch 56 by setting a switch-control signal (denoted SW) to SW=“1”. During PHASE 1, the output of BG reference circuit 48 is connected to capacitor 52 and to the output port. The reference voltage supplied by BG reference circuit 48 (denoted BG_VOLTAGE in FIG. 3) is provided as the output voltage of circuit 24 (denoted VREF in FIG. 3). The reference voltage supplied by BG reference circuit 48 is also used for charging capacitor 52.

In PHASE 2, control circuit 60 retains BG reference circuit 48 in an active state (retains EN=“1”), but opens switch 56 by setting SW=“0”. PHASE 2 is a preparatory or transition phase, prior to disabling BG reference circuit 48, and is intended to prevent undesired transient voltages that might be formed on the output port during disabling of BG reference circuit 48.

In PHASE 3, control circuit 60 retains switch 56 in an open state (retains SW=“0”), and disables BG reference circuit 48 by setting EN=“0”. During PHASE 3, BG reference circuit 48 is disconnected from capacitor 52 and the output port. The output voltage of circuit 24 (denoted VREF in FIG. 3) is supplied by capacitor 52. As seen in FIG. 3, capacitor 52 gradually discharges along PHASE 3, and therefore VREF gradually drops from VREF to VREF−ΔVREF. Techniques for reducing the rate of decrease of VREF (which in turn enable extending the length of PHASE 3) are addressed further below.

PHASE 4 is another preparatory or transition phase, prior to enabling BG reference circuit 48, intended to prevent undesired transient voltages on the output port. In PHASE 4, control circuit 60 retains switch 56 open (retains SW=“0”), and enables BG reference circuit 48 by setting EN=“1”.

FIGS. 2 and 3 depict a single period of the four-phase pattern. Typically, control circuit 60 repeats this pattern periodically. Alternatively, in some embodiments the pattern may comprise only PHASE 1 and PHASE 3 (i.e., without transition phases PHASE 2 and PHASE 4), or the pattern may comprise only one of the transition phases (PHASE 2 or PHASE 4).

At the end of PHASE 1, the voltage across capacitor 52 is equal to the reference voltage supplied by BG reference circuit 48 (BG_VOLTAGE). The capacitor can be viewed as “memorizing” BG_VOLTAGE, and supplying this voltage during PHASE 3 in which BG reference circuit 48 is disabled.

The performance gain achieved by circuit 24 can be best understood with reference to FIG. 3. As seen in the timing diagram, BG reference circuit 48 is enabled with a very small duty cycle. In particular, BG reference circuit 48 is inactive throughout PHASE 3, which is by far the longest phase in the periodic pattern. Therefore, even though the instantaneous current consumption of BG reference circuit 48 is approximately 13.3 μA, the average current consumption of circuit 24 as a whole is only approximately 1.2 μA. At the same time, the output voltage of circuit 24 (VREF) is highly stable and accurate.

The durations of PHASE 1, PHASE 2, PHASE 3 and PHASE 4 are denoted T1, T2, T3 and T4, respectively. In some embodiments, control circuit 60 (typically part of AON logic 28) comprises logic (e.g., one or more Flip-Flops and auxiliary logic) that derives signals EN and SW from the clock signal supplied by LPO 40. This clock signal has no stringent precision requirements, thereby enabling the LPO to consume only ˜300 nA. The period of the clock signal supplied by LPO 40 (in the present example 1/(256 KHz)) is thus equal to the period of the pattern of EN and SW (T1+T2+T3+T4).

In an embodiment, T1 is chosen to be sufficiently long so as to (i) allow BG reference circuit 48 to stabilize, and (ii) allow capacitor 52 to re-charge from VREF−ΔVREF back to VREF. T1 is thus dependent on the stabilization time constant of BG reference circuit 48. T2 is chosen sufficiently long to ensure that switch 56 is off before BG reference circuit 48 is disabled. T4 is chosen sufficiently long to allow BG reference circuit 48 to stabilize before connecting switch 56. Like T1, T4 is also dependent on the stabilization time constant of BG reference circuit 48.

T3 is chosen to be as long as possible, as long as the voltage drop ΔREF is within specified precision limits. In some embodiments, T2 is considerably smaller than T1, T3 and T4 (e.g., 1 nS), and is generated by a small delay element rather than derived independently from the clock signal of LPO 40. An example implementation having actual numerical values for T1, T2, T3 and T4 is described further below. Alternatively, however, any other suitable time durations can be used.

As noted above, the achievable reduction in power consumption is directly related to the fraction of time during which bandgap circuit 48 is disabled, in the present example the ratio between the length of PHASE 3 (T3) and the combined length of the other phases. The maximal length that can be chosen for T3 depends on ΔVREF, the amount of decrease of VREF during PHASE 3. The decrease in VREF, in turn, is determined by the leakage of switch 56. Therefore, any reduction in the leakage of switch 56 enables an increase in T3, and translates directly into lower average power consumption.

FIG. 4 is a circuit diagram showing current leakage in a switched bandgap reference circuit, in accordance with an embodiment that is described herein. In this example, switch 56 is modeled by a transistor that is biased with a drain-source voltage (Vds) of 1V. The leakage current of this transistor (for large Vds) is denoted I_leak. Charge injection current (denoted I_inj) from LDO 36 is assumed negligible in “deep-sleep” mode. The “block” element at the bottom-right of the figure represents LPO 40 and LDO 44 (seen in FIG. 1).

In various embodiments, the tolerable maximum value of ΔREF may be, for example, on the order of 100 μV, 1 mV, or 10 mV, and is given by:

$$Δ VREF = \frac{( I\_leak + I\_inj ) \cdot T 3}{C} \qquad Equation 1$$

wherein C denotes the capacitance of capacitor 52. Therefore, T3 is given by:

$$T 3 = \frac{Δ VREF \cdot C}{I\_leak + I\_inj} \qquad Equation 2$$

When designing circuit 24, it is important to reduce any kickback effects on VREF (charge injection originating from elements such as LDO 36), e.g., using buffers or filtering. Circuit layout and shielding have a strong impact on this performance.

In an example implementation, switch 56 is implemented using a single N-channel MOSFET having a length of 1μ and a width of 0.27μ. At a temperature of 125° C. and Vds=1V, the leakage current I_leak is on the order of 175 pA (pico-Ampere) or less. In some practical implementations, a leakage current of 175 pA may be too high, because it limits T3 to 5.7 us (for ΔVREF=1 mV and C=1 pF). The description that follows suggests an alternative implementation for switch 56, which reduces the leakage current to approximately 2 pA. Such a low leakage current enables extending T3 up to approximately 500 us (for ΔVREF=1 mV and C=1 pF), thereby reducing current consumption considerably.

FIG. 5 is a circuit diagram that schematically illustrates a low-leakage switch 64 used in a switched bandgap reference circuit, in accordance with an embodiment that is described herein. The switch depicted in FIG. 5 is suitable for implementing switch 56 of FIG. 1 above. In this embodiment, switch 64 comprises three transistors connected in a T-network configuration.

In the example of FIG. 5 the transistors comprise three N-channel MOSFETS denoted SW1, SW2 and SW3. The source of SW1, the drain of SW2 and the drain of SW3 are connected to one another, to form the junction of the T-network. The source of SW2 serves as the switch input (connected to the output of BG reference circuit 48). The drain of SW1 serves as the switch output (connected to capacitor 52 and to the output port of circuit 24). The gates of SW1 and SW2 are connected to ground. The gate and source of SW3 are biased with positive voltages VDD2 (1.6V) and VDD1 (0.9V), respectively. As seen in FIG. 1, these voltages are produced by regulator 32 for other purposes, and therefore their generation does not require additional hardware. Moreover, there is no stringent precision requirement on these voltages. In an embodiment, the gates of the three transistors SW1, SW2 and SW3 are connected to suitable control logic, which selectably connects each gate to ground or to some supply voltage depending on the phase. FIG. 5 presents a simplified view of this scheme, referring to the biasing of the transistors when the switch is off (SW=“0”), i.e., during PHASE 2, PHASE 3 and PHASE 4.

The biasing scheme described above creates a potential of 0.9V at the junction of the T-network, and thus at the source of SW1. VREF in this embodiment is 1.0V, and therefore the Vds across SW1 is only 0.1V. Due to the small Vds, the leakage current through SW1 (and thus through switch 64 as a whole) is approximately 2 pA. As noted above, such a low leakage allows extending T3 up to 500 us (for ΔVREF=1 mV and C=1 pF).

In various embodiments, various design procedures can be used for setting the various parameters of circuit 24. In one example embodiment, the following procedure is used:
1. Simulate the maximal leakage current I_leak (Fast-Fast (FF)/125° C.), and the injection current I_inj, over variations in Process, Voltage and Temperature (PVT). This simulation provides the value of I_leak+I_inj.
2. Calculate the maximal tolerable ΔVREF, for the required precision.
3. Choose the capacitance C of capacitor 52, taking into consideration that C affects T1.
4. Calculate T3 from the previously-calculated parameters in accordance with Equation 2 above.
5. Choose the values of T1 and T4 for the required precision using simulation over PVT. If the resulting T1 is too high, go back to step 3 and modify the capacitance C. Repeat until T1 is acceptable.
6. Calculate the minimal clock rate of LPO 40, which satisfies Fclk>1/min(T1,T4). Tclk is given by 1/Fclk.

In the above design procedure, the choice of capacitance C is a trade-off between chip area and power consumption. Larger C means larger T3 but also larger T1. Smaller C means smaller T1 but also smaller T3.

In an example execution of the above design procedure, the following numerical values are derived:
1. Simulation yields I_leak=20 pA at FF/125° C., including variation of VDD1 and VDD2 over PVT. Simulation also yields I_inj=0, no dynamic current on the output of LDO 36.
2. Specified VREF=975 mV, and specified precision of 1% (9.75 mV).
3. Desired capacitance set to 1 pF, for implementation using a MOS capacitor (MOSCAP).
4. Resulting T3=500 μS, including simulation of required refreshing time to reach ΔVREF<9.75 mV over PVT.
5. T1 and T4 are on the order of 30 μS, assuming the power consumption of bandgap reference circuit 48 is Ibg=13.3 μA. This calculation also considers settling time of bandgap circuit 48 with 1% precision. In order to support T1 and T4 values on the order of 30 μS, the LPO clock rate over PVT should be larger than 34 KHz (˜1/30 μS).
6. T2 can be set as low as 1 nS.
7. The resulting calculated average power consumption of bandgap circuit 48 is Iavg<Ibg·(Tclk−T3)/Tclk=13 μA·60 μS/560 μS=1.4 μA. In simulation, the average power consumption was lower, only 0.6 μA. The difference is due to the fact that bandgap circuit 48 starts-up during T4. This effect is accounted for in the simulation but not in the calculation.

In an example simulation of circuit 20 over PVT, including real blocks for AON logic 28, LPO 40, bandgap circuit 24 and LDO 36, the following performance was predicted:
1. VREF start-up time is less than 20 μS, and VREF variation in “deep-sleep” mode is less than 1 mV.
2. Average current consumed by bandgap circuit 24 is approximately 0.6 μA.
3. Bandgap is 2.2% @3σ (22 mV @3σ), therefore VREF is 23 mV @3σ. (In this example, the variation of the bandgap voltage VBG is 22 mV over PVT. The additional error due to leakage is 1 mV, yielding the total variation of 23 mV.)
4. An ultra-low-power bandgap circuit having similar continuous-time power consumption would achieve much lower precision.

The circuit configurations described herein, e.g., the configurations of power supply circuit 20, switched bandgap reference circuit 24, and switch 56, shown in FIGS. 1, 2, 4, and 5, are example configurations that are depicted solely for the sake of clarity. In alternative embodiments, any other suitable circuit configuration can also be used. Circuit elements that are not mandatory for understanding of the disclosed techniques have been omitted from the figure for the sake of clarity. The different circuit elements are typically implemented using dedicated hardware or firmware, such as in one or more Application-Specific Integrated Circuits (ASICs) or Field-Programmable Gate Arrays (FPGAs).

In some embodiments, the circuits described herein, e.g., power supply circuit 20, switched bandgap reference circuit 24, and switch 56, shown in FIGS. 1, 2, 4, and 5, are implemented in a sub-micron (e.g., 0.028μ, i.e., 28 nm) Complementary Metal Oxide Semiconductor (CMOS) process. Alternatively, any other suitable implementation or fabrication process can be used.

Although the embodiments described herein mainly address ultra-low power communication devices such as NFC devices, the methods and systems described herein can also be used in other applications, such as in any electronic device that uses reference voltages and is to have very low power consumption.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An electronic circuit, comprising:
a bandgap circuit, configured to generate a predefined reference voltage;
a capacitor coupled to an output port of the electronic circuit on which an output voltage is to be provided;
a switch connected between the bandgap circuit and the capacitor; and
a control circuit, configured to control the bandgap circuit and the switch so as to alternate between:
first time intervals, during which the bandgap circuit is enabled and connected to the capacitor, the capacitor is charged using the reference voltage generated by the bandgap circuit, and the reference voltage is provided as the output voltage on the output port; and
second time intervals, during which the bandgap circuit is disabled and disconnected from the capacitor, and the output voltage on the output port is supplied from the capacitor.

2. The electronic circuit according to claim 1, wherein the control circuit is configured to transition between the first time intervals and the second time intervals by setting interim time intervals in which the bandgap circuit is enabled but disconnected from the capacitor.

3. The electronic circuit according to claim 1, wherein the switch comprises three transistors connected in a T-network configuration.

4. The electronic circuit according to claim 1, wherein an average current consumption of the electronic circuit is lower than an instantaneous current consumption of the bandgap circuit.

5. The electronic circuit according to claim 4, wherein the instantaneous current consumption of the bandgap circuit, when enabled, is higher than 13 μA, and wherein the average current consumption of the electronic circuit is lower than 1 μA.

6. The electronic circuit according to claim 1, wherein the bandgap circuit, the capacitor, the switch and the control circuit comprise sub-micron Complementary Metal Oxide Semiconductor (CMOS) components implemented in a single Integrated Circuit (IC).

7. A method for supplying electrical power, the method comprising:
operating a bandgap circuit that is configured to generate a predefined reference voltage, a capacitor coupled to an output port on which an output voltage is to be provided, and a switch connected between the bandgap circuit and the capacitor; and
controlling the bandgap circuit and the switch so as to alternate between:
first time intervals, during which the bandgap circuit is enabled and connected to the capacitor, the capacitor is charged using the reference voltage generated by the bandgap circuit, and the reference voltage is provided as the output voltage on the output port; and
second time intervals, during which the bandgap circuit is disabled and disconnected from the capacitor, and the output voltage on the output port is supplied from the capacitor.

8. The method according to claim 7, wherein controlling the bandgap circuit and the switch comprises transitioning between the first time intervals and the second time intervals by setting interim time intervals in which the bandgap circuit is enabled but disconnected from the capacitor.

9. The method according to claim 7, wherein the switch comprises three transistors connected in a T-network configuration.

10. The method according to claim 7, wherein an instantaneous current consumption of the bandgap circuit, when enabled, is higher than 13 μA, and wherein an average current consumption of the electronic circuit is lower than 1 μA.

11. The method according to claim 7, wherein the bandgap circuit, the capacitor, the switch and the control circuit comprise sub-micron Complementary Metal Oxide Semiconductor (CMOS) components implemented in a single Integrated Circuit (IC).
